(19) United States
(12) Patent Application Publication
(10) Pub. No.: US 2005/0036728 A1
(43) Pub. Date: Feb. 17, 2005

(54) Curved surface for improved optical coupling between optoelectronic device and waveguide

(76) Inventor: Henning Braunisch, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/640,212

(22) Filed: Aug. 12, 2003

(51) Int. Cl. G02B 6/26

(52) U.S. Cl. 385/14; 385/146

(57) ABSTRACT

A waveguide has a curved surface to redirect light from a first significant axis to a second significant axis. The curved surface may comprise multiple distinct angled segments or facets or may comprise a graduated curve.

### FIELD

The subject matter disclosed herein generally relates to the field of optical and/or optoelectronic circuits and in particular relates to techniques to improve optical coupling between an optoelectronic device and a waveguide.

### DESCRIPTION OF RELATED ART

Waveguides have been used as a medium for propagating light signals. In some cases a surface angled at 45 degrees is used to change the axis of propagation of the light signal to a different axis, such as by 90 degrees. However, optical coupling using a 45 degree angle tends to be lossy because of partial transmission at the angled surface and scattering into the cladding.

### BRIEF DESCRIPTION OF THE DRAWINGS

FIG. 1A is a schematic diagram showing one embodiment of an optical system employing a waveguide having a curved surface for improved optical coupling.

FIG. 1B is a schematic diagram showing one embodiment of an optical system that incorporates a light source and waveguide having a curved surface situated on a first circuit board, and a photodetector and waveguide having a curved surface situated on a second circuit board.

FIG. 2 is a schematic diagram showing an enlarged cross sectional view of one end of a waveguide of FIG. 1A or 1B, in which a curved surface having multiple angled segments or facets is shown.

FIG. 3 is a schematic diagram showing an enlarged cross sectional view of one end of a waveguide of FIG. 1A or 1B, in which a curved surface having a graduated curve is shown.

FIG. 4 shows a schematic diagram of a cross section of an optical system comprising an optical assembly having a waveguide with curved surfaces inserted into through-holes in a substrate to optically couple two optoelectronic components.

FIG. 5 is a flowchart showing a method of assembling an optical system.

FIG. 6 is a flowchart showing a method of forming the curved surface of a waveguide.

Note that use of the same reference numbers in different figures indicates the same or like elements.

### DETAILED DESCRIPTION

A method and apparatus for improved optical coupling between an optoelectronic device and a waveguide is described herein. By improving the optical coupling, the signal to noise ratio at the optical receiver, or photodetector, is improved.

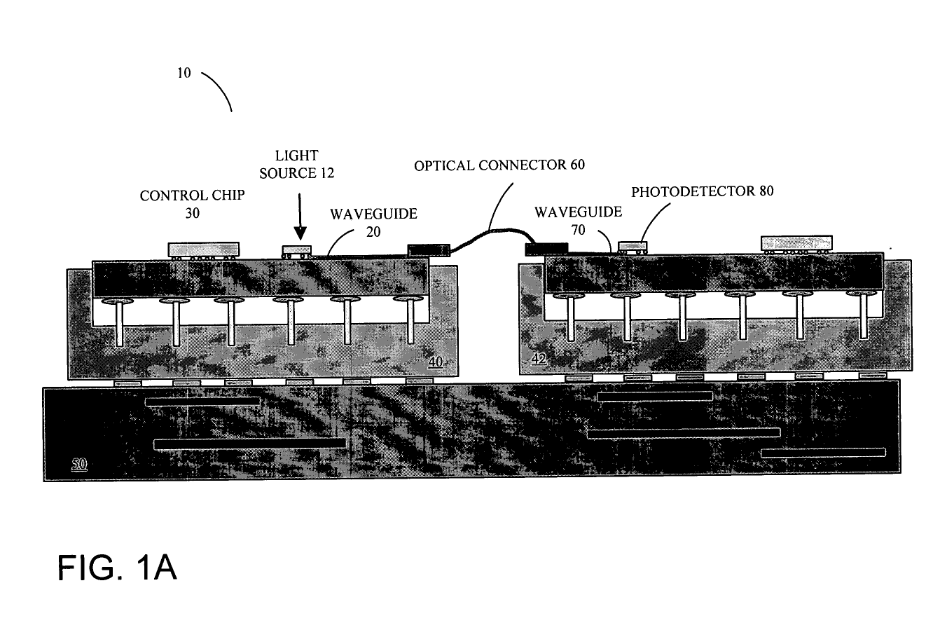

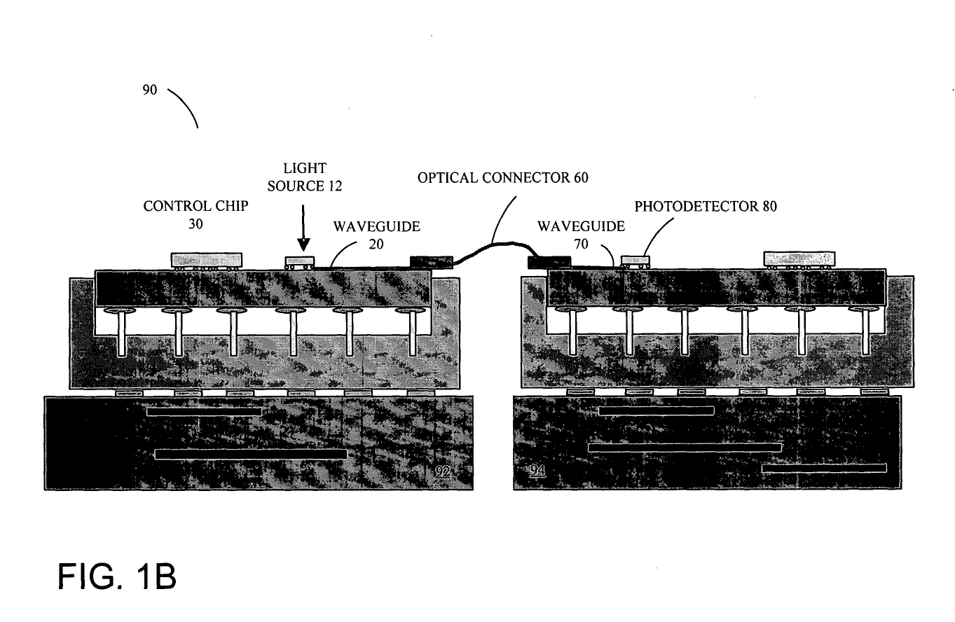

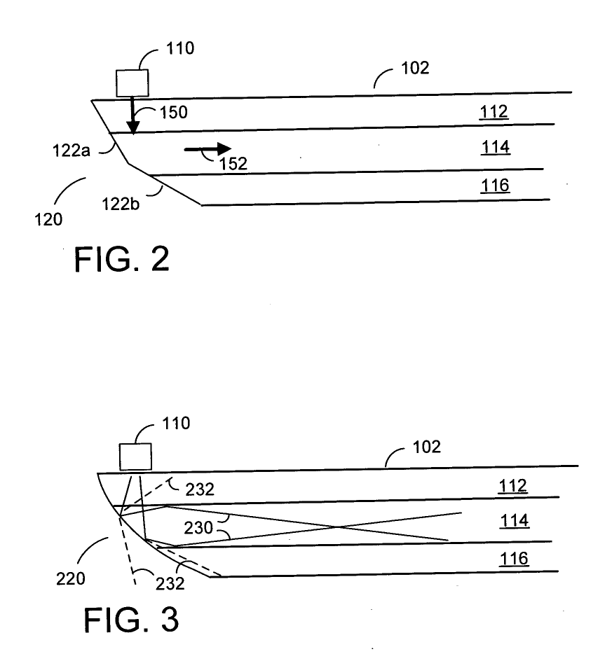

FIG. 1A is a schematic diagram showing one embodiment of an optical system 10 employing a waveguide 20 having a curved surface (shown in more detail in FIGS. 2 and 3) for improved optical coupling. In this embodiment, a first and a second assembly 40 and 42 are mounted to a printed circuit board 50. The first assembly comprises a light source 12, such as a VCSEL (Vertical-Cavity Surface-Emitting Laser). Light source 12 is optically coupled to one end of waveguide 20.

An opposite end of the waveguide 20 is optically coupled to a photodetector 80. In one embodiment, the photodetector 80 is mounted on a separate assembly than the light source 12. The photodetector 80 may be optically coupled to the waveguide 20 via an optical connector 60 and a second waveguide 70.

In one embodiment, the first assembly 40 also comprises a control chip 30 that provides control signals to the light source 12. For example, control chip 30 may modulate the light emitted from light source 12 by direct modulation of an electrical drive current. The first and second assemblies 40 and 42 may be mounted to a circuit board 50. In one embodiment, the first and second assemblies are socketed, and the sockets are surface mounted to the circuit board 50.

FIG. 1B is a schematic diagram showing one embodiment of an optical system 90 that incorporates a light source 12 and waveguide 20 having a curved surface situated on a first circuit board 92, and a photodetector 80 and waveguide 70 having a curved surface situated on a second circuit board 94. Although the two circuit boards 92 and 94 are shown side by side for simplicity, the circuit boards 92 and 94 could be in separate rooms and/or could be in separate electrical systems, e.g., in two separate computer systems optically coupled by the optical connector 60.

In one embodiment, the system described with respect to FIGS. 1A and 1B may be used with an optical bus architecture. For example, the light source 12 may be part of an array of light sources, waveguides 20 and 70 may be part of an array of waveguides, photodetector 80 may be part of an array of photodetectors, and optical connector 60 may be replaced by an optical bus connector.

FIG. 2 is a schematic diagram showing an enlarged cross sectional view of one end of a waveguide 102, such as waveguide 20 or waveguide 70 of FIGS. 1A and 1B, coupled to an optoelectronic device 110, such as light source 12 or photodetector 80 of FIGS. 1A and 1B.

In one embodiment, the waveguide 102 comprises cladding 112 and 116 and a core 114. The waveguide 102 has a curved surface 120, which may comprise two or more distinct angled segments or facets such as 122a and 122b, as shown in FIG. 2.

The angled segments or facets of the curved surface may be formed in numerous ways, such as by microtoming or laser ablation. The curved surface could alternatively be formed through a molding process at the same time that the waveguide is formed. In one embodiment, the curved surface 120 is a graduated curve that smoothly varies without significantly distinct angled segments or facets.

The curved surface aids in redirecting light incoming from a first significant axis 150, such as from a light source directed down into the waveguide, into light directed out in a second significant axis 152, such as directed into the waveguide. In the current case, the incoming light is redirected at a 90 degree angle, however, the curved surface and the waveguide could be modified to change the angle of redirection.

Similarly when light incident in a first significant axis hits that curved surface, it will be optically coupled more efficiently into a photodetector situated in a second significant axis from the curved surface. Thus, the curved surface of the waveguide assists at both the interface for the light source and at the interface for the photodetector.

FIG. 3 is a schematic diagram showing a cross sectional view of one end of a waveguide 102 having a graduated curved surface 220. The waveguide 102 is optically coupled to an optoelectronic device 110.

In one embodiment, the waveguide 102 comprises glass or an organic material such as a polymer, polycarbonate, polyimide, polycyanurates, polyacrylate or benzocyclobutene (BCB). However, various other optical materials may alternatively be used. In one embodiment, the waveguide 102 is formed in a molding process, such as injection molding.

FIG. 3 also illustrates a divergent light beam 230 hitting the curved surface 220 and reflecting into the core of the waveguide. The curved surface 220 assists in focusing the divergent light beam into the core. Light 232 that would have been lost through scattering into the cladding or by partial transmission through a prior art surface angled at 45 degrees is illustrated in dotted lines.

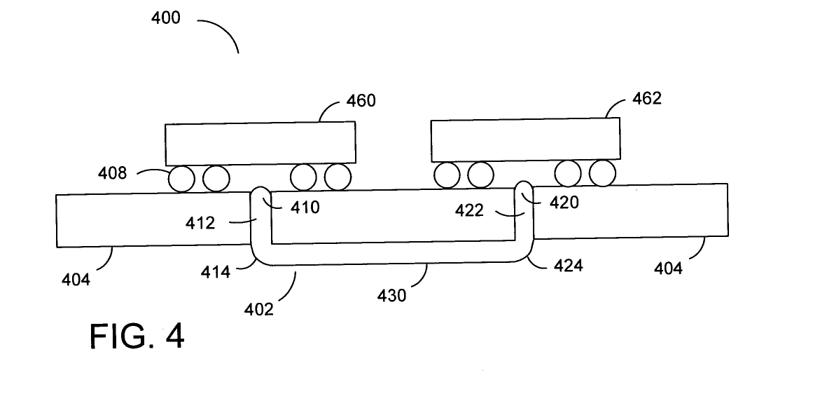

FIG. 4 shows a schematic diagram of an optical system 400 comprising an optical assembly 402 inserted into through-holes in substrate 404 to optically couple two optoelectronic components 460 and 462. The optical assembly 402 may be permanently coupled, e.g., by an adhesive or epoxy, to the substrate or board 404, and the optoelectronic components 460 and 462 may be coupled to substrate or board 404, e.g., by flip chip bonding using solder balls 408.

In one embodiment, the optical assembly 402 comprises a lens portion 410, an optical spacer 412, and a coupler 414 on one end, and a second lens portion 420, a second optical spacer 422, and a second coupler 424 on the other end. The two couplers having curved surfaces for improved optical coupling are coupled together via an optical waveguide 430.

In one embodiment, the optical assembly 402 comprises glass or an organic material such as a polymer, polycarbonate, polyimide, polyacrylate, polycyanurates or benzocyclobutene (BCB), or a combination thereof. However, various other optical materials may alternatively be used. The optical assembly 402 may be formed in a molding process, such as injection molding. The waveguide of the optical assembly 402 can alternatively be fabricated via a planar or linear manufacturing process, in which a waveguide is formed between cladding regions. The lens and spacer portions can be subsequently attached to the planar waveguide, and the coupler portions 414 and 424 may be formed by laser ablation, microtoming or molding.

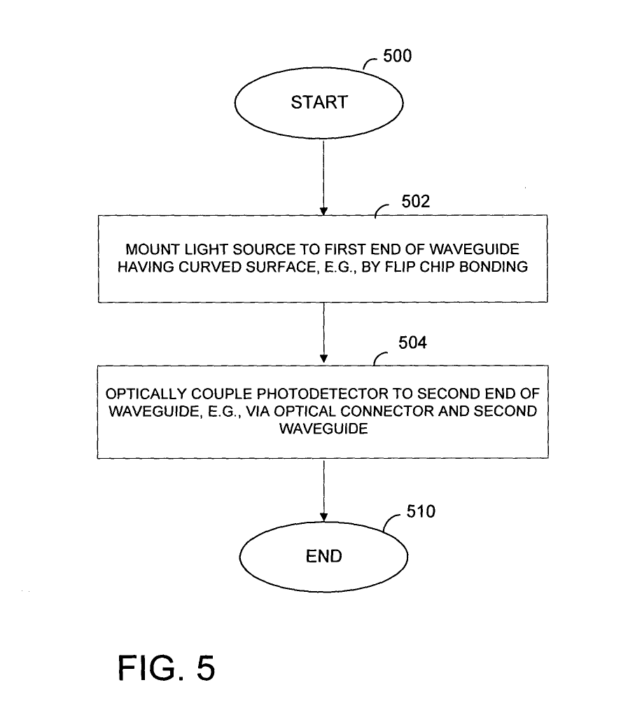

FIG. 5 is a flowchart showing a method of assembling an optical system. The flowchart starts at block 500 and continues at block 502, at which a light source is mounted to a first end of a waveguide having a curved surface. In one embodiment, the light source is mounted via a flip chip process using solder balls. The flowchart continues at block 504 at which a photodetector is optically coupled to the other end of the waveguide. In one embodiment, the photodetector is coupled indirectly to the first waveguide via an optical connector and/or a second waveguide. The flowchart ends at block 510.

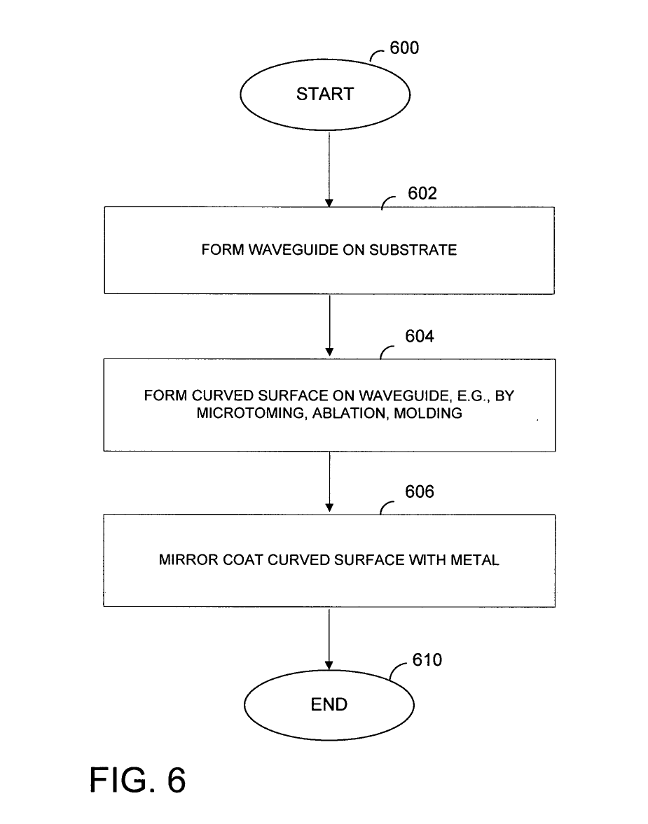

FIG. 6 is a flowchart showing a method of forming the curved surface of a waveguide. The flowchart starts at block 600 and continues at block 602, at which the waveguide is formed. The flowchart continues at block 604, at which a curved surface is formed on the waveguide. The curved surface may be formed in a variety of different ways, such as by microtoming, laser ablation, or via a molding process. The curved surface may be optionally coated in metal to form a mirrored surface to aid in increasing optical coupling at the curved surface, as shown at block 606. The flowchart ends at block 610.

Thus, a method and apparatus for improving optical coupling of a waveguide is disclosed. However, the specific embodiments and methods described herein are merely illustrative. For example, although some of the detailed description refers solely to a substrate, a circuit board may be similarly employed. Numerous modifications in form and detail may be made without departing from the scope of the invention as claimed below. The invention is limited only by the scope of the appended claims.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

1. An apparatus comprising:
a waveguide having a curved surface to redirect light from a first significant axis to a second significant axis, the curved surface comprising at least two different angles; and
an optoelectronic device positioned in optical alignment with the waveguide.

2. The apparatus of claim 1, wherein the curved surface of the waveguide comprises three or more distinct angles.

3. The apparatus of claim 1, wherein the curved surface of the waveguide comprises a graduated curve.

4. The apparatus of claim 1, wherein the optoelectronic device is a light emitter positioned to provide an optical signal in the first significant axis.

5. The apparatus of claim 1, wherein the optoelectronic device is a photodetector optically coupled to receive light from the waveguide.

6. The apparatus of claim 1, wherein the waveguide comprises one of glass, polycarbonate, polyimide, polycyanurates, polyacrylate or benzocyclobutene (BCB).

7. The apparatus of claim 1, wherein the curved surface is metallized.

8. A system comprising:
a first waveguide having a first curved surface to redirect light having a first significant axis to a second significant axis;
a second waveguide having a second curved surface to redirect light having a third significant axis to a fourth significant axis;
a light source coupled to provide light in the first significant axis to the first waveguide;
an optical connector to couple light from the first waveguide to the second waveguide; and
a photodetector coupled to receive light in the fourth significant axis from the second waveguide.

9. The system of claim 8, wherein the first curved surface comprises at least two distinct angles, and the second curved surface comprises at least two distinct angles.

10. The system of claim 8, wherein the first curved surface and the second curved surface are graduated curves.

11. The system of claim 8, further comprising:
a circuit board, wherein the first waveguide and the second waveguide are attached to the circuit board.

12. The system of claim 11, wherein the second significant axis and the third significant axis are in planes substantially parallel to the circuit board.

13. The system of claim 8, wherein the optical connector couples light from the second significant axis of the first waveguide to the third significant axis of the second waveguide.

14. The system of claim 13, wherein the first significant axis and the second significant axis are approximately perpendicular to each other.

15. The system of claim 14, wherein the third significant axis and the fourth significant axis are approximately perpendicular to each other.

16. A method of manufacturing an optical system comprising:
mounting a light source in optical alignment with a first waveguide having a curved surface adapted to redirect light input into a first end of the first waveguide from the light source to an opposite end of the first waveguide;
optically coupling the opposite end of the first waveguide to a photodetector.

17. The method of claim 16, wherein the optically coupling the opposite end of the first waveguide to the photodetector further comprises:
optically coupling the first waveguide to a second waveguide having a curved surface, wherein the photodetector is optically aligned to receive light reflected from the curved surface of the second waveguide.

18. The method of claim 17, further comprising:
optically coupling the first waveguide to the second waveguide via an optical connector.

19. The method of claim 18, wherein the first waveguide and the second waveguide are on different circuit boards.

20. The method of claim 16, wherein mounting the light source in optical alignment with the first waveguide further comprises:
mounting the light source using flip chip bonding.

21. A method of manufacturing a waveguide having a curved surface comprising:
forming a waveguide on a substrate;
using one of microtoming, ablation or molding to form a curved surface on the waveguide.

22. The method of claim 21, wherein the curved surface is formed having two or more distinct angles.

23. The method of claim 21, wherein the curved surface is formed having a graduated curve.
